(19) United States
(12) Patent Application Publication
(10) Pub. No.: US 2024/0425281 A1
(43) Pub. Date: Dec. 26, 2024

(54) METHOD AND SYSTEM FOR OPTIMIZING A WAREHOUSE

(71) Applicant: Verses Technologies USA, Inc., Los Angeles, CA (US)

(72) Inventors: Capm Syrys Sam PETERSON, Los Angeles, CA (US); Gabriel Joseph Bradley RENE, Los Angeles, CA (US); Steven Aaron SWANSON, Culver City, CA (US); Alec Daniel Dunsmoir TSCHANTZ, Brighton (GB); Aidin ESLAMI, Los Angeles, CA (US); Mohammed Nadeem SAFDER, Los Angeles, CA (US); Charles Drake POOLE, Lawton, OK (US); Joel Abraham SPIELBERGER, Los Angeles, CA (US); Mrudul Bindu BHATT, Liverpool (GB); Sam Ruaridh SUTTON, Liverpool (GB); James Alexander COHEN, London (GB)

(21) Appl. No.: 18/693,486

(22) PCT Filed: Sep. 21, 2022
(86) PCT No.: PCT/US22/44275

§ 371 Date: Mar. 19, 2024

Related U.S. Application Data
(60) Provisional application No. 63/360,286, filed on Sep. 21, 2021.

(51) Int. Cl. B65G 1/137; G05D 1/244; G05D 105/28; G05D 107/70; G06Q 10/087

(52) U.S. Cl. CPC B65G 1/1378; G05D 1/2446; G06Q 10/087; B65G 2203/0216; G05D 2105/28; G05D 2107/70

(57) ABSTRACT

In a system and method for placing and picking items in a warehouse. the correct location of the item is displayed on a virtual depiction of the warehouse. the person tasked with placing or picking an item is visually guided to the item in question. and the placement of items and movement of persons and goods is optimized for the warehouse.

### FIELD OF THE INVENTION

The present invention relates to the picking and placement of items in a warehouse or other storage facility.

### BACKGROUND OF THE INVENTION

Warehouses typically comprise numerous rows of shelf racks, which in their simplest form may be arranged in a grid structure. Depending on the shape and configuration of the building, the storage space may comprise a number of sub-regions, each comprising one or more rows of shelf racks. The racks themselves may comprise multiple vertically-demarcated shelves, with each shelf supporting multiple bins or containers for items that are stored in the warehouse.

Typical warehouse management systems (WMSs) provide an address like “LA-101-35-3-F” to define the location of a particular item. The picker who has to locate a particular item then has to identify the location based on pre-existing knowledge of the warehouse and rack layout, or a manual diagram of the warehouse that lays out the floor plan and rack distribution according to the particular address nomenclature used by the warehouse in demarcating the various rows, shelf racks and shelves. However, it is up to the individual to position him or herself relative to the diagram and then count the number of rows, and racks to identify the rack location. The picker may then identify the particular bin corresponding to the address code. In some cases the bins or articles (also referred to herein as items) may include a bar code, allowing the picker to scan the code with a mobile bar-code scanner to verify the item being sought. It will, therefore, be appreciated that this requires the picker to perform multiple tasks, from manually locating his or her position in the warehouse, the location of the particular rack in an x-y dimension, the path to the rack, and finally, the location vertically of the correct shelf in the z direction. All of this is time consuming and translates into real costs for a business.

The same applies to the placement of items on the shelves. By relying on a manual locating approach as discussed above, the placement of new inventory is not only time consuming but subject to human error. If items are placed on a rack in the wrong section or row, or on the wrong shelf, it makes it virtually impossible later to locate that item.

The traditional approach for defining tasks to be performed in locating and shipping product or for placing new inventory on the shelves, involves the use of spreadsheets listing the various tasks, and specifying where the items are found on the shelves. This fails to provide an overview of how items are distributed in the warehouse, or whether their placement is optimized, or whether the pickers' tasks are optimized to most efficiently pick all of the items scheduled for the day.

The present invention seeks to address these problems.

### SUMMARY OF THE INVENTION

According to one aspect of the invention, there is provided a system for locating an item in a warehouse comprising: a user tracking device; location markers or visually identifiable features associated with sections or items in the warehouse, wherein the tracking device includes a processor with control memory configured with machine readable code defining an algorithm; at least one location information capture device connected to the processor for capturing information from one or more of the location markers or visually identifiable features, and a user screen for displaying to a user, a2-dimensional or 3-dimensional virtual representation of the warehouse, wherein one of said algorithms is configured to use the information captured by the location information capture device to spatially locate the user in the warehouse, and display the location of the user on the virtual representation (digital twin) of the warehouse, and wherein the algorithm is configured to display the location of the item on the virtual representation of the warehouse. For purposes of this application, the term algorithm may include multiple algorithms and may include a machine learning algorithm.

The algorithm may include logic for defining the optimum route from the location of the user to the location of the item.

The algorithm may include logic for generating an augmented reality (AR) image as an overlay to a view of the warehouse to guide the user to a defined location in the warehouse.

The location markers may include one or more of: beacons (e.g., radio or ultrasonic beacons), floor markers and barcodes located on one or more of: warehouse floor, warehouse racks, shelves on the racks, containers on the shelves, or items in the warehouse, including users and carts used by users. For purposes of this application the term barcode is used generally to refer to any scannable image, including a traditional bar code, QR code, April code, etc.

The at least one location information capture device may include one or more of: beacon signal receiver, a video camera, and a barcode reader. The system may include a video camera mounted to capture location markers on the floor of the warehouse, and a barcode reader for providing more detailed location information of the tracking device or for validating an item to be located. The location information capture device may include one or more of: stationary and movable cameras. The stationary cameras may be mounted to capture video data of aisles in the warehouse. The movable cameras may be mounted on users or carts used by users.

The algorithm may include one or more of: logic for interpreting barcode information captured by the cameras, and logic for generating bounding boxes. The stationary cameras and algorithm may be configured to define a user's location by capturing one or more of barcode information mounted on the user or cart used by the user, and interpreting changes in the size of a bounding box around the user or cart used by the user.

The system may, further, comprise a memory configured with item data that includes identifying information (e.g., SKU (Stock Keeping Unit) and location data for each item or for each container containing an item or family of items.

The item data (e.g., SKU) may include barcodes, and the location data may be defined by the location markers or visually identifiable features.

The virtual representation may further, include a virtual representation of the shelves with a visual identifier for the location of the item of interest on the shelves.

The system may further, include a hand-operated barcode scanner for scanning barcodes on items or shelves in order to validate the item or shelf of the item of interest, the algorithm generating a visual or audible confirmation that the correct item or shelf has been scanned or issuing an alert that the wrong item or shelf has been scanned.

The tracking device may be mounted on a cart and the at least one image capture device may include one or more of: a forward-facing video camera for capturing images of floor markers, and a side-facing video camera for capturing images of barcodes on shelves. The barcodes on the shelves may include a barcode for each section, which may comprise one or more racks.

The user screen may also include a virtual representation (digital twin) of the cart, which may include multiple compartments for receiving items, with visual depiction of what compartment to place the item in. The system may also include a microphone to audibly guide the user. This audible guidance may include vocalized instructions guiding the user to the item and identifying what compartment to place the item in.

The system may further comprise a mobile printer connected to the processor for printing shipping labels for items to be shipped.

Further, according to the invention, there is provided a method for identifying the location of an item in a warehouse, comprising generating a virtual twin of the warehouse, visually depicting the item on the virtual twin of the warehouse by providing the item with an item identifier, and location information for spatially defining its location in the warehouse, providing a tracking device connected to one or more sensors for capturing the location of a user in the warehouse, and generating a visual depiction on the virtual twin of a route from the user to the item.

The method may include supplementing the visual guidance of the user with auditory guidance using a speaker.

The sensors may include one or more of: a beacon signal receiver for reading beacon signals, a camera for capturing images of barcodes attached to users or users' carts or distributed throughout the warehouse.

The virtual twin may further, include a virtual representation of the shelves with a visual depiction of the item on the shelf corresponding to the spatial information of the item identifier. The virtual twin may also include a virtual representation of the cart, which may have multiple compartments for receiving items, with a visual depiction of which compartment to place the item in.

Still further, according to the invention, there is provided a method of improving warehouse efficiency, comprising classifying items in the warehouse in order of priority based on frequency of picking, defining one or more primary regions in the warehouse that are optimally located for shipping items, and visually depicting in the spatial warehouse, the optimum distribution of each item relative to the primary region in accordance with each item's priority level. The method may also include taking into account location on a rack as a factor in optimizing distribution.

The method may include providing a virtual twin of the warehouse and spatially depicting the items in the warehouse on the virtual twin.

The method may further include tracking activities performed on items by depicting activities on the virtual twin.

The method may further include depicting current locations of items on the virtual twin, as well as their optimum distribution.

The screen displaying the virtual twin may also show activities to be performed on an item and the time taken and path traveled in performing the activity.

The method may include providing both a visual overview of the warehouse and its workers, as well as a means for optimizing efficiency. The method includes showing all users (picker, placers, etc) in real time on a digital twin of the warehouse.

The method may include including a dashboard to provide access to all assignments per picker. The assignments may include one or more of: current, historical, and future assignments.

The dashboard may include the option to display different pick types allocated to each picker for the day: wave, discrete and fast.

The dashboard may display task assignments by brand and by user.

The method may include viewing total picks per hour (TPH), as well as total time taken by each picker and total time of all pickers per day and number of assignments completed that day. The method may include optimizing the number of pickers that are required, based on a known number of assignments to be performed in a given time-frame.

The method may include optimizing distances between items and fulfillment zones (also referred to as shipping or packing locations) based on frequency of picks of said items and distance or time to a fulfilment zone.

Still further, according to the invention, there is provide a method for improving warehouse efficiency, comprising identifying the location of a user and of at least one item to be picked or placed, and determining the optimum path from the user to the at least one item. The optimum path may be the shortest distance or shortest time path. The optimum path may be displayed on a user screen to visually guide the user to the at least one item. The user may also be guided to the at least one item by means of auditory instructions. Insofar as the picker is required to pick multiple items at different locations, the method may include determining the optimum order in which to pick the items.

Still further, according to the invention, there is provided a method of managing inventory tasks, comprising defining items in inventory as assets with asset identifiers, location information, and contracting information that expresses tasks as permissions within temporal and spatial bounded routes.

The spatial information may further include user validation information.

The method preferably includes generating virtual assets for physical assets.

As a way of spatially positioning assets, the method may comprise spatially anchoring the virtual assets relative to one or more reference asset locations.

Still further, according to the invention, there is provided a method of validating the movement of goods from one location to another location, comprising
defining at least one of goods, and containers housing the goods, as assets,
associating spatial information with each asset, wherein the spatial information includes an asset transaction permission contract.

The asset transaction permission contract may further include range of movement of the asset and may include route information defining the route the asset is to take as part of the asset transaction permission contract.

The asset may include information about relative location of an asset within another asset.

A valid range of movement of the asset may be visualized as part of a view query, and may be defined in various dimensions.

The dimensions may include at least one of time, temperature, and location.

As part of the asset transaction permission contract, the asset may include at least one of a signature, public key, and biometric information as a requirement for the permission.

The signature may include a cryptographic signature of a requester that can be validated against a public key.

### BRIEF DESCRIPTION OF THE DRAWINGS

FIG. 1 shows an example of a warehouse with one embodiment of a system of the invention;

FIG. 2 shows the system of FIG. 1 in greater detail in the form of a tracking device implemented as part of a cart arrangement, and

FIG. 3 is one embodiment of a user interface with a 2D depiction of part of a virtual warehouse floor plan with rack and shelf distribution;

FIG. 4 shows one embodiment of a user interface with a rack and collection cart depiction;

FIG. 5 is a flow chart of one embodiment of the logic for optimizing the path from a fulfillment zone to each item location;

FIG. 6, is a flow chart of one embodiment of the logic for optimizing the order for picking or placing objects in a multi-assignment project;

FIG. 7, is a flow chart of one embodiment of the logic for optimizing the placement of items in a warehouse;

FIG. 8 shows one embodiment of an admin user interface for showing performance of a picker,

FIG. 9 shows one implementation of the conversion process from a database task to a visual depiction,

FIG. 10 shows the three steps involved in the conversion from database query to view query,

FIG. 11 shows a one example of importing some of the basic types that COSM works with, and

FIG. 12 shows one implementation of the dataflow for the capture and processing of streaming data.

### DETAILED DESCRIPTION OF THE INVENTION

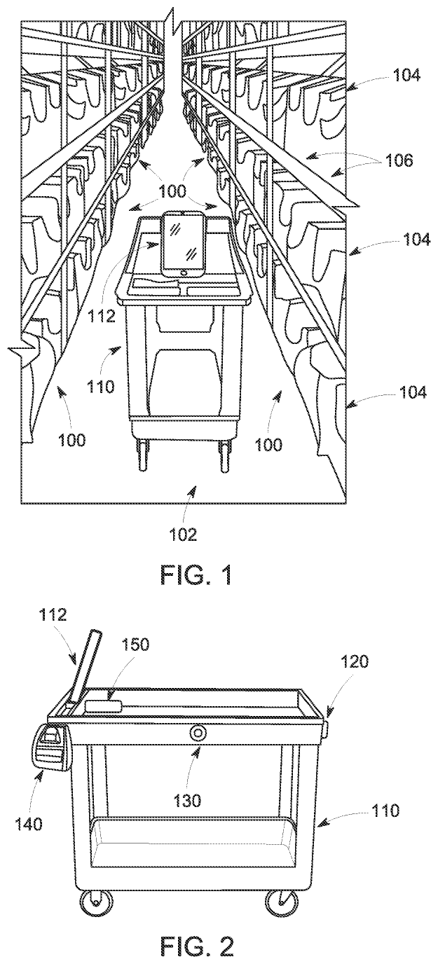

FIG. 1 shows an example of a typical warehouse with multiple racks 100 aligned in rows to define aisles 102 in between. Each rack 100 is vertically sub-divided into shelves 104, each with multiple bins 106 (also referred to herein as containers) for housing items in the warehouse.

FIG. 1 shows just one embodiment of a system of the invention. In this case it comprises a cart 110 with a display screen (also referred to herein as a user screen) that in this embodiment is implemented as a tablet 112. This embodiment of the system is shown in greater detail in FIG. 2.

As shown in FIG. 2, the tablet 112 is mounted on the cart 110. In this embodiment the tracking device, which will be discussed in greater detail below, includes the tablet 112 and is connected to various sensors. The control algorithm is implemented on the tablet, which includes a processor and control memory configured with software code defining the algorithm to monitor the location of the tracking device, and thus the location of the user.

In order to provide a user with a visual overview of the warehouse and what they are doing, the warehouse configuration and dimensions are captured, e.g., using a Lidar. By capturing geospatial information and creating holographic overlays using tools like Unreal Engine, the system allows augmented reality (AR) direction indicators to be provided on a user's AR glasses or tablet screen.

In a simpler, more cost-effective implementation, a rough approximation of the warehouse space can be generated using a CAD model of the space, to which the shapes and relative locations of racks are added. Thus, the space is translated into a virtual representation (also referred to herein as a virtual twin or dollhouse) of the warehouse, the racks, and the shelves in two-dimensional or three-dimensional format.

Items on the racks are traditionally provided with identifying information, e.g., an SKU (or Stock Keeping Unit), which is a unique number used to internally track a business' inventory. SKUs are alphanumeric, and provide information on the characteristics of a product, e.g., price, color, style, brand, gender, type, and size, etc. The present invention supplements this identifying information with location data to define where each item is located in a warehouse. This allows the location of an item that is to be picked, to be visually depicted on the display screen. In one embodiment the optimum path (e.g., shortest distance or shortest time from the user to the item is displayed on the screen.

In one implementation of the virtual warehouse depiction on the user screen, the top left corner of the virtual representation is assigned the coordinates 0,0,0 for x, y, and z dimensions. In this implementation x=left/right; z=up/down on the page; and y defines vertical dimensions to accommodate rack heights and multiple floors to a warehouse, in which case y could be 3 meters.

Insofar as the racks allow bin storage on both sides of the racks, the present embodiment defines rotation, wherein everything facing up on the page (z-direction in this implementation) is defined as 0 degrees; everything facing right is 90 degrees; everything facing down on the page is 180 degrees and everything facing left is 270 degrees.

In order to identify the various racks or sections, identifiers (also referred to as way points) are added to each rack or section.

As mentioned above, the tracking device is connected to sensors, which in this embodiment comprises two cameras. A front camera (also referred to herein as a forward-looking camera) 120 captures images of markers on the floor of the warehouse in order to identify the location of the tracking device in the warehouse and visually depict this on the virtual representation of the warehouse on the display screen of the tablet 112. Thus, one aspect of the invention is to allow the location of a user to be monitored by spatially tracking the tracking device and visually depicting it on a display screen. The system also includes a side mounted camera 130 for reading barcodes on racks 100 (which in this implementation define sections) or on shelves 104. This embodiment also has a mobile printer 140 for printing shipping labels once a picker has located the item of interest. In another embodiment, only the side-mounted camera is used in conjunction with way points associated with the sections to identify the location of the tracking device.

In order to provide extended power to the various electronic items (tablet 112, forward-facing camera 120, side mounted camera 130 and printer 140), the system also includes an external battery 150.

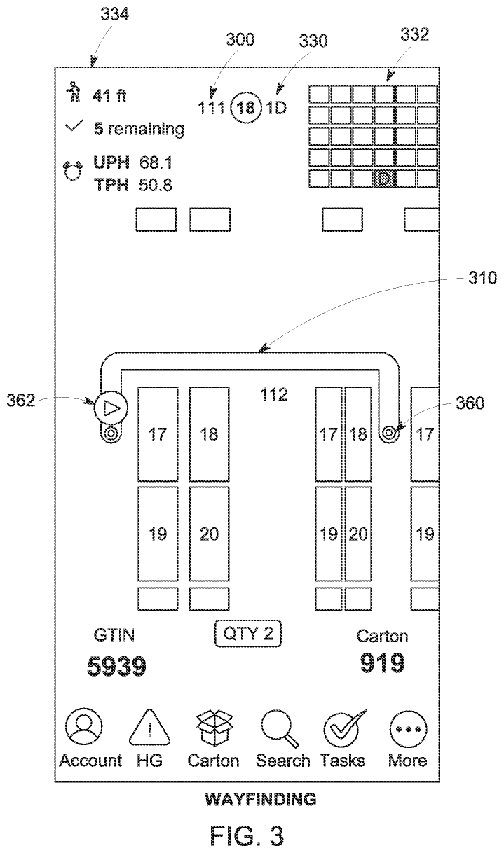

FIG. 3 shows one embodiment of a user interface on the display screen of tablet 112. Once the user requests the system to locate and present the first assignment, a two-dimensional (2D) representation of a virtual warehouse floor plan showing the distribution of the rows 300 of racks 110, defining the aisles 102 on either side of the rows 300 appears on the display screen. It will be appreciated that in another embodiment this 2D representation may instead be implemented as a 3D image and displayed on the display screen of the tablet 112. In the present embodiment the path from the tracking device to the item of interest is visually shown by a guiding line 310 which guides the picker to the location of the item of interest 320 using floor markers as discussed in greater detail below.

The location of the picker (also referred to as a user in this context) can be identified in a number of ways. In one embodiment images or barcodes are located on the floor, which are captured by the forward-facing camera 120. In another embodiment the side-mounted camera on the cart captures barcodes on the racks or shelves. Since the location of the images or barcodes (generally referred to herein as markers) on the floor or shelves are known, the location of the picker's tracking device can be spatially identified and translated into an image on the virtual warehouse image.

As is discussed further below, an algorithm, which may for example be on the control memory of the tablet, determines the shortest or fastest path from the picker to the item that needs to be picked or to the location of the shelf that an item is to be placed on. This can then also be visually depicted on the screen of the tablet as a guiding line or path from the picker to the shelf location in question, as was discussed above. Thus, it will be appreciated that a person placing new inventory on the shelves (also referred to herein as the placer), may similar to the picker who selects items from the shelves, be guided to the correct shelf location using a guiding line similar to that shown in FIG. 3. Since users (pickers and placers) will typically have multiple tasks to be performed, involving, for example, the picking of items from various locations, the present invention also calculates the most efficient order for collecting the items based on minimum distance or minimum time for completing all of the tasks.

In the above embodiment floor markers were used for the forward-facing cameras 120 to guide the picker or placer. However, in other embodiments, other methods may be used to define the location of the picker or placer. For example, the card may only include the side-mounted camera as discussed above, or the pickers and placers may carry a radio beacon or ultrasound beacon, which may be mounted on the cart. These beacons may communicate with corresponding transceiver beacons distributed at strategic locations of the warehouse, e.g., on the various racks. In one embodiment RFID chips are placed at various locations of the warehouse, and pickers and placers carry RFID readers to locate their position relative to the RFID chips and allow their positions to be spatially defined on the virtual warehouse image.

In addition to the guiding path 310, the display screen of the tablet provides the picker (or placer) with numerical guiding information to the rack where the item of interest is to be found (or placed). In this embodiment, this is done by defining the aisle 300 (in this case aisle number 111) and the shelf and bin number (in this case it is shelf number 1 from the bottom and bin D as shown by the numerical depiction 330). Also, a corresponding visual representation of the rack is provided as depicted by reference numeral 332. The person is also told how far they are from the appropriate rack (in this case 41 feet, as shown by depiction 334).

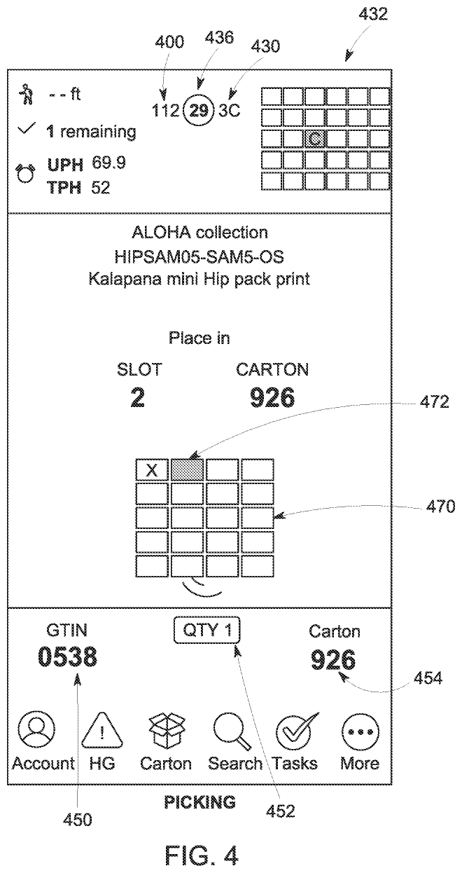

In order to guide the user to the correct shelf and bin once they are in front of the correct rack, and to guide the user in placing the item in the correct compartment in the cart, the screen changes as shown by FIG. 4 in this embodiment. The shelves and bins are visually displayed as before, in the form of a virtual representation of the rack 432 with the correct bin lit up (in this example bin C (also referred to as column C) in row 3). This is also numerically displayed by numerical depiction 430, which confirms the shelf and bin location. It also shows the aisle number 400 (in this case aisle number 112), which is the aisle adjacent the rack 432 of interest. It also shows the section 436 that the item is in (in this case section 29).

The display screen in this embodiment also includes the item number (GTIN) 450 (which in this case is 0538), the quantity of items 452 to be picked (in this case 1 item), and the carton number 454 in which the items are located (in this case carton number 926).

The picker may also be provided with a hand-held barcode scanner to scan a barcode on the bin to verify that the correct bin has been located. If the correct bin is scanned the virtual depiction of the rack 432 lights up with a confirmation indicator, e.g., a green light at said location of the image, or a confirmation message. Similarly, if the wrong bin is scanned the virtual depiction 432 will light up at said incorrect location in a different color e.g. red, or by flashing an error message.

In the present embodiment, where a user is using a cart with multiple compartments, the user screen also includes a visual depiction of the cart 470, together with a visual depiction of the compartment or slot 472 that the picked item is to be deposited into or where the item to be placed on the shelf is located in the cart. This may be supplemented with microphone information to audibly guide the user to the bin for picking or placing, and the correct slot associated with the item of interest.

As mentioned above, the tracking device is implemented as part of the tablet 112 in this embodiment, and includes a processor and memory configured with an algorithm to capture the information from the cameras 120, 130 and analyze this for determining where the device is in a warehouse. It will be appreciated that the processing may be done locally at the tablet or remotely, or a combination of the two. In one embodiment the tablet includes a native local app that defines the 2D depiction of the relevant section of the warehouse as shown in FIG. 3, with start point 360 (where the user is located), the end point 362 (where the item to be picked is located), the guiding path 310, and the virtual depiction of the rack 332

In another implementation, instead of working off a CAD image of the warehouse, the rendering of the warehouse as a 2D depiction may be a manually-entered, using rough approximation of the boundaries of the warehouse, and showing the rows 300, the individual racks 110 making up the rows, and the aisles 102 in between the rows.

In yet another embodiment, where a more accurate depiction of the warehouse layout is desired, the depth and relative location of objects in the warehouse can be measured by means of LIDAR or using a camera as discussed in U.S. Pat. No. 10,049,500, which involves first capturing the spatial parameters of the environment. However, for purposes of the present invention, the ability to track the location of the tracking device relative to rows 300 and racks 110 is more important than the precision of the outer boundaries or accuracy of depicting distances between rows, as long as actual distances to be traveled between user and the item to be picked is accurately defined for purposes of path optimization and for presentation to the user to guide the user to the item. In the above embodiment, the cart with its tracking device, simply needs to know where it is relative to any row and rack, and must be able to associate a particular physical rack with its virtual 2D version. As indicated above, this is achieved in the above embodiment by placing visually unique markers on the floor of the warehouse, along the aisles 102, in front of each rack 110. The forward-facing camera 120 captures images of the markers, which the processor compares to pre-stored marker images in data memory. As with the processor and control memory, the data memory may be local (on the tablet 112) or the processing of the image data can be performed remotely, e.g. at a dedicated server or on a cloud server system such as AWS, or can be performed partially intermediately, e.g. using an edge computing implementation.

By identifying the position of the tracking device based on the particular marker it is capturing or communicating with, the spatial location of the user is known and can be depicted on the screen by associating the image of the device in front of the image of the rack corresponding to said marker. Similarly, the identification information (e.g. SKU) of all items in the warehouse can be entered into the tablet together with location information for each item. In one embodiment a database in the storage memory includes all item identification information and corresponding row, rack, shelf, and bin information. By associating the aisle and rack information with the item identification information, the algorithm instructs the processor to generate an image of the destination location and draw the guiding line from the user at the tracking device to the destination location.

In the above embodiment a floor marker was associated with each rack 110. In another embodiment floor markers only guide the tracking device to the correct row or the correct adjacent aisle, whereafter the side-mounted camera 130 scans bar codes on the racks to identify the correct rack location. In another embodiment, only the side-mounted camera is used to identify the location of the tracking device 130, and thus the location of the user.

In yet another embodiment, stationary video cameras are mounted at various locations in the warehouse, e.g., facing down each aisle and connecting paths. These are used to track barcodes attached to each cart or each user. As in the above embodiments, the term barcode is used in this application to refer to conventional barcodes, QR codes, April codes, etc. By capturing images of the user or cart barcode from at least two viewpoints using two cameras, the location of the user can be trigonometrically determined. As a further refinement, that the image information of the user or cart is analyzed using a bounding box and tracking the relative size change of the box to define distance and direction of travel of the user or cart. In a preferred embodiment, multiple tracking modalities are combined to improve accuracy of spatially defining the location of the user, e.g., using a moving camera in the form of a side-mounted camera on the cart, and using stationary cameras overseeing the aisles and pathways. In addition to visually guiding the user using a preferred path, as shown on the tablet screen, a speaker (e.g., the tablet's speaker) can be used to provide the user with oral cues to guide the user to the item.

As mentioned above, the item identification information is also associated with rack information, which includes the shelf and bin information. This allows the virtual depiction of the racks, also referred to herein as the grid depiction 332, 432 of the rack to be populated by a highlighted image of the bin associated with the item being sought, and the information to be numerically displayed as was discussed above with respect to FIGS. 3 and 4.

Also, as mentioned above, in order to validate the correct bin, the present embodiment includes a handheld or other mobile barcode scanner, e.g., Zebra glove or Arcos ring, to scan a UPC or GTIN code on the corresponding bin, which can then give visual confirmation of the correctness of the bin choice or generate an error message/image as discussed above.

The present invention this allows a user (e.g., picker or placer of items) to readily be guided to the correct location, saving time and money, and to optimize the path to the item by choosing the shortest distance or quickest path.

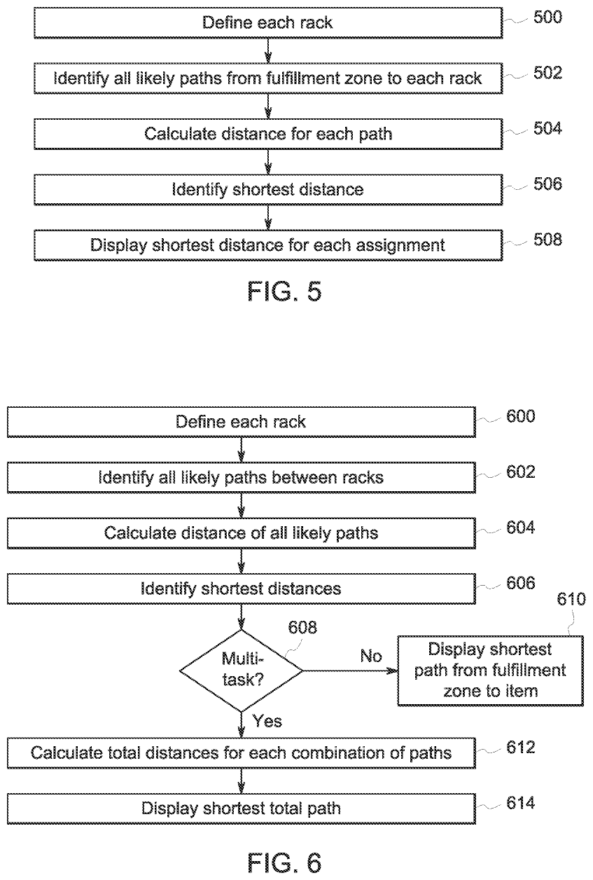

One embodiment of the logic associated with the path optimizing algorithm is shown in FIG. 5. In this case it defines the optimum route from a fulfillment zone A to the item location. In step 500, each rack is defined by an identifier. In step 502 each likely path from the fulfillment zone A to each rack is identified. In step 504 the distance is calculated for each of said likely paths. In step 506, the shortest distance is identified from the zone A to each rack, and in step 508, when an assignment is identified to a user, the display screen displays the shortest route from Zone A to the item of interest. This assumes that the user is starting off at the fulfillment zone A. After that the algorithm calculates the shortest distance from the user's current location to the next item as defined by the next assignment.

Another aspect of the invention involves optimizing the order of picking items in a multi-assignment project. The logic of one embodiment of an algorithm for performing this assignment order optimization is shown in FIG. 6.

In step 600, each rack is identified. In step 602 all likely paths are identified from each rack to each other rack. In step 604 the distance for each of said likely paths is calculated and in step 606 the shortest distance is identified for each path from one rack to any other rack. In decision step 608 a determination is made whether the project includes multiple assignments. If Not the display screen simply displays the shortest path from the fulfillment zone to the rack of the item in question (step 610). If the answer to the decision step is Yes, the total distance for each combination of paths from the fulfillment zone to rack corresponding to an assignment item is calculated (step 612), and in step 614 the shortest total path is displayed on the user display screen.

Another aspect of the present invention is the optimization of item distribution in a warehouse. Each time an item is picked, the present system allows the total time taken to retrieve the item to be captured, allowing a profile to be formed for the efficiency of each picker and the ease or difficulty of retrieving a particular item. Thus, items located in the middle of a rack, as opposed to near the top or bottom of a rack, may be more easily or more quickly retrieved. Similarly, items closer to the location of packaging or shipping may present the picker with a shorter picking path and thus reduce retrieval time. In this way each location in the warehouse can be defined on a scale from most to least optimum and can be color coded on the virtual representation (digital twin) of the warehouse.

Similarly, some items or types of items in a warehouse may be more popular or require more frequent picking. By grouping items into groups of frequency of picking (pick frequency), a hierarchy of item importance can be created, which can again be depicted on the virtual representation as different colors for each group. It thus provides a visual overview of where the optimum locations are and where the most sought-after items are, allowing the most sought-after items to be re-allocated to locations that are optimum. This allows picking and placing times to be reduced, improving efficiency and reducing costs. Since the times to each location are captured by the system, the time-saving and thus the cost-saving, based on work hours saved, as a result of the re-allocation of items can be calculated by the system and presented to the user.

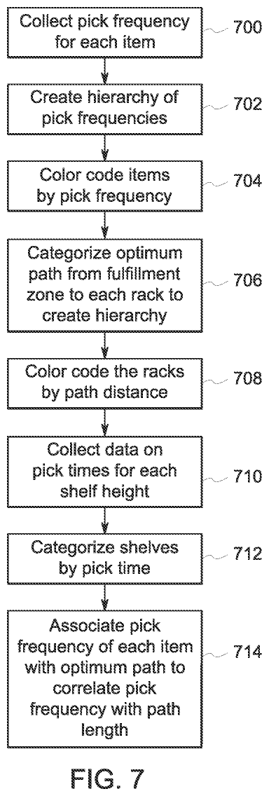

Thus, the placement of items in a warehouse can be optimized. The logic of one embodiment of an algorithm to perform this item placement optimization is shown in FIG. 7.

In step 700 the pick frequency of each item or class of items is collected. In step 702 a hierarchy of pick frequencies is created for the items or class of items. In step 704 this hierarchy of pick frequencies is depicted on the user screen of an administrative portal by color coding the items on the virtual twin. In step 706 the optimum paths from fulfillment zone to each rack is categorized. In step 708 the racks are color coded in the admin portal according to the distance from the fulfillment zone. The distance information to the racks is supplemented with additional time information based on shelf height in step 710 by collecting data on the pick times for each shelf height. In step 712 the pick times are used to categorize shelves according to pick times. In step 714 the pick frequency of each item is then associated with an optimum path and pick time such that the highest pick frequency item corresponds to the shortest optimum path and pick time, and the lowest pick frequency item corresponds to the longest optimum path and pick time.

The present system provides both a visual overview of the warehouse and its workers, as well as a means for optimizing it. For instance, it allows all users (picker, placers, etc) to be seen in real time on a digital twin of the warehouse.

In one implementation, a dashboard provides access to all assignments per picker-current, historical, and future assignments.

The different pick types allocated to each picker for the day: wave, discrete and fast can be displayed.

The task assignments by brand and by user can be displayed.

Total picks per hour-(TPH) can be viewed, as well as total time taken by each picker and total time of all pickers per day and number of assignments completed that day. This allows the number of pickers that are required, to be optimized based on known number of assignments to be performed in a given time-frame.

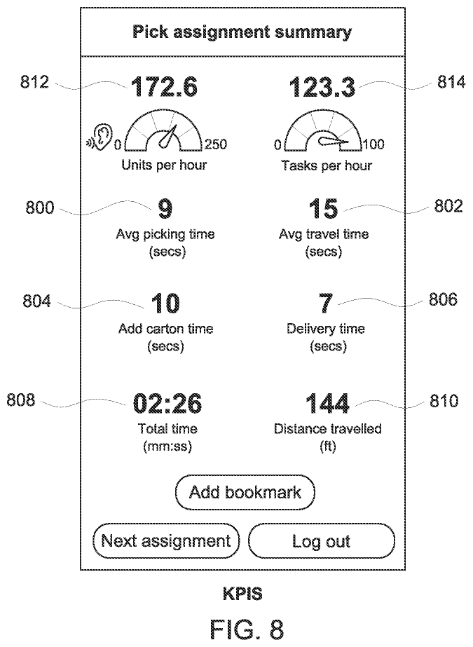

FIG. 8 shows one embodiment of an admin portal showing pick data on a particular picker (user). It shows the picker's average picking time 800 for a multi-assignment project for taking an item off a shelf and placing it into the cart, their average travel time 802 for the assignments, the time to add a carton 804, and the delivery time 806. It also shows the total time 808 for the project and the total distance 810. It also shows the total units 812 collected per hour and the total tasks 814 completed per hour.

While the above examples discussed distances form a fulfillment zone (also referred to herein as a shipping or packing zone) it will be appreciated that warehouses may have more than one fulfillment zone.

In one implementation of the present invention, the asset definitions and communications logic is implemented using the Hyperspace Transaction Protocol (HSTP). HSTP is described in the parent application, which is incorporated herein by reference, and can be thought of as uniquely combining the communications protocol, the layout or markup language, and spatial contracting language that deals with permissions. These three aspects are traditionally separated into different protocols such as HTTP and HTML and JavaScript in the browser stack, but are combined in HSTP.

There are three fundamental and related message types within the spatial communication protocol:
VIEW—a query which defines the requested viewable area, which is missing from purely filename-based protocols like HTTP. As is discussed in greater detail below, it includes Hyperspace range queries, which allow the viewer to specify the area and time within which they wish to view assets.
RESULT/STATE—which provides the identity, spatial contents and permissions of related assets.
TRANSACTION—which defines an expression of an update to the state of one or more assets, in a manner that allows efficient validation.

The benefit of adopting a spatial transaction protocol like HSTP, is that it allows spatial information of any physical, digital or hybrid (i.e. “digital twin”) asset to be registered and transacted with. An asset may therefore comprise an article, a person interacting with an article, spaces within which articles are located or involved in the movement of articles. Each of these assets may be defined by an identifier (DID) as discussed further below. This may be implemented using a cluster of graph-like databases able to communicate via a set of spatial queries, transactions and permissions that factor in: (i) the size and shape of an asset (such as an item in a warehouse, a rack, a shelf or the warehouse itself); (ii) its geographic, celestial and/or virtual position (Thus the position may be a specific geo-spatial location on Earth or may be defined in relation to other related objects. Thus, the position information may comprise spatially anchoring the virtual assets relative to one or more reference asset locations. An asset may thus include information about relative location of the asset within another asset); (iii) its proper display resolution when reproduced digitally; (iv) any permissions that govern the behavior of the asset or what may be done with the asset or who may move it; and (v) in certain cases its time and frequency.

Visualization and spatial anchoring of assets and contracts are thus performed by means of spatial queries.

Thus, in this embodiment, the HSTP provides for spatial querying, returning of spatial content and related information about assets, requesting changes to those assets, defining spatial permission contracts for transactions over those assets, and describing how these may be distributed and routed over a network.

Using the protocol, allows contracts to be spatialized for efficient visual representations of all the interrelationships between contracting parties from a spatial perspective Files that are downloaded include the spatial smart contracts associated with each of those assets, which define how the assets can move/be modified, and any other permissions so that when an asset is downloaded you know what you can do with it and are constrained by those permissions. Thus, the spatial information associated with each asset, includes an asset transaction permission contract, which may include route information. A range of movement and route of the asset may be visualized as part of a view query (as was discussed above with the guiding line on the user display), and may be defined in various dimensions, and is not hard coded in the view query.

Using the HSTP protocol also allows a requesting user's identity to be validated to confirm that their authorization complies with the permission constraints of the asset. For instance, the asset may include a signature (e.g., cryptographic signature of a requester that can be validated against a public key), public key, or biometric information.

The protocol also supports spatial quantized range queries, which allow for the requesting of files in a certain geographic area.

In this embodiment, HSTP therefore acts as the signaling and logic control that keeps track of assets and relates them spatially to each other, acting as arbiter in allowing or disallowing transactions, such as movement of assets to a new space.

In any spatial transaction we need to know the Who, What, Where, When and How. The Who (owners of assets, and requesters), the What (which defines the assets involved in the transaction), and the Where (which defines the spatial space) may be captured in any suitable database, e.g. graph database, which may be centralized or distributed over multiple nodes. The When is a time dimension that can be associated with an asset. The How defines the terms of the transaction and is based on the ontological space.

By conferring rights on certain spaces, the protocol allows for domains to be defined.

For example, if an item in a warehouse is moved from the warehouse to shipping container or truck, it is now in a completely different reference frame with respect to the original warehouse, yet the differences in other reference frames (e.g. current city, country and/or planet) likely have not changed all that much. Each would need an incremental change that would be reflected as matters of degree, which the current invention tracks and synchronizes in real-time.

As indicated above, a spatial asset comprises a “digital twin” of a real-world, physical object, location, or person, or a virtual representation of a real-life building or “avatar” of a human being. The “digital twin” stays in “sync” between the virtual and real worlds through sensors (e.g. cameras, RFID etc,), or through oral-based input mechanisms.

Each asset is given a unique identifier, along with its own specific properties such as location, contract, content, etc. which provides for provenance or historical tracking via blockchain type transaction chain hashing.

In an implementation of HSTP using graph databases, assets can form the nodes in the graph database, with their relationships (ontological space) defined by the edges. In one embodiment the Neo4j graph database is used to store assets as nodes, with their properties existing as links between the nodes.

This also allows a Spatial Index to be maintained for all of the assets.

In one implementation of a Spatial Index, the following information is defined for each spatial asset:
Asset identifier (DID) for any article, domain or person (e.g., agent, owner or authority); including a uniquely identifying string, which can include public-key encryption information.
SPACIAL DOMAIN and OWNER, which may be on separate ledgers in which case the full DID of the asset must be specified.
LOCATION, which includes one or more dimensions, preferably including range and resolution, and optionally with transform/bounds of any inner content. Standard supported dimensions include X, Y, Z, LAT, LON, ALT, and TIME. By providing for ranges, instead of being limited to points, it allows for INSIDE, TOUCHING and OUTSIDE to be evaluated contractually for each space occupied by an asset.
CONTRACT, which is an expression that defines the validity of any transaction within its scope, both spatially and with respect to ownership.
CONTENT

And in some cases a WALLETVALUE, which is a positive scalar value representing the wallet value of this asset.

Thus, any picking or moving of items in a warehouse can be considered in terms of a contract or set of contracts. The visualization of a contract in a warehouse context involves multiple steps. Inventory is converted into spatial assets and the task of picking an item and moving it from point A to point B is a spatial contract. As a first step, traditional data entries, such as tasks in the warehouse, are converted into spatial assets and contracts. In one embodiment the contracts are visualized simply as text diagrams. Preferably however, each contract is visualized by drawing arrows between where the user is, and where they need to find the item, and then arrows between the item and the box it should be placed in. The items and goal shapes specified in the contract can thus be visualized. For example, it can convert the text “pick item ABC” into visual highlights in the digital twin that highlight the item and the box.

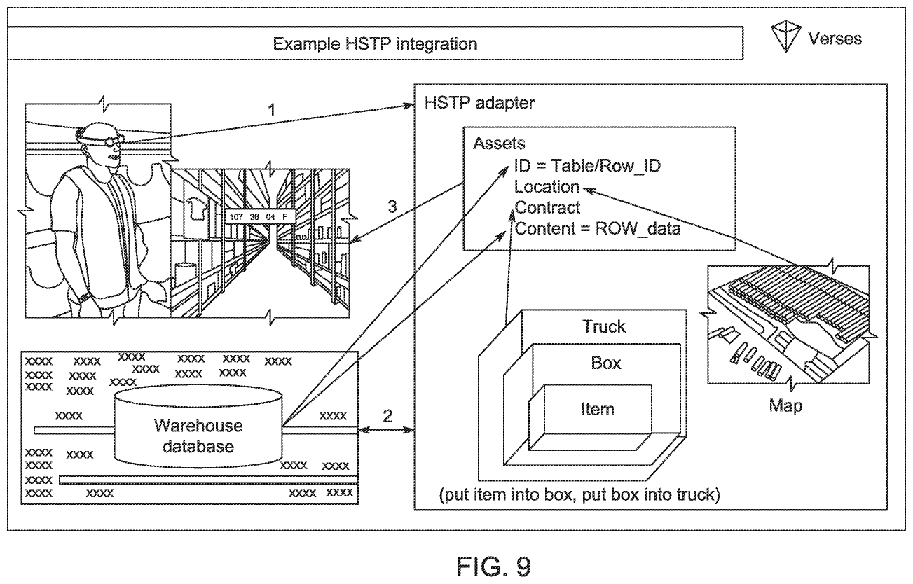

In one embodiment, an HSTP operating system platform, referred to as COSM, assists in the conversion process. COSM converts traditional data entries, such as tasks in a warehouse as defined in a spreadsheet, dynamically into spatial assets and contracts. Specifically, the adapter receives HSTP queries, translates those into database queries, and then translates the results back into HSTP asset representations. This assetization process includes both spatialization (adding spatial information) as well as contracting, where the object API is translated into valid asset transactions, as is discussed in greater detail below with respect to FIG. 9. In one embodiment this adapter is written as a Node.js instance with both HTTP/HSTP endpoints and database querying functionality. This allows numerous HSTP clients to directly interact with and complete existing workflows.

The result is shown in FIG. 9, where a user in a warehouse sees existing tasks as spatial assets and contracts. This conversion to a visual process involves three main components:
1. Adapter, where existing database entries are mapped into general assets that reference the source table, id and authority. This typically comprises asset information obtained from the Warehouse database, including ID=Table/ROW_ID, and CONTENT=ROW_DATA.
   2. Spatialization, where the assets are spatialized by relating those assets to a map (as depicted by “map” in this example), but also by allowing users to orient themselves by estimating their view based on visible assets (this view triangulation is a key component to spatialization, especially in high visual redundancy areas such as warehouses).
3. Contracting, where any existing object methods or API interactions with the data are translated into a set of valid HSTP transactions and then combined into a single contract that specifies all permissioned interactions. For example, in this particular implementation, the task of putting a particular item in a box and putting the box in a truck, is visually presented to the user via virtual reality glasses and spatially mapped into the environment on a 1:1 scale.

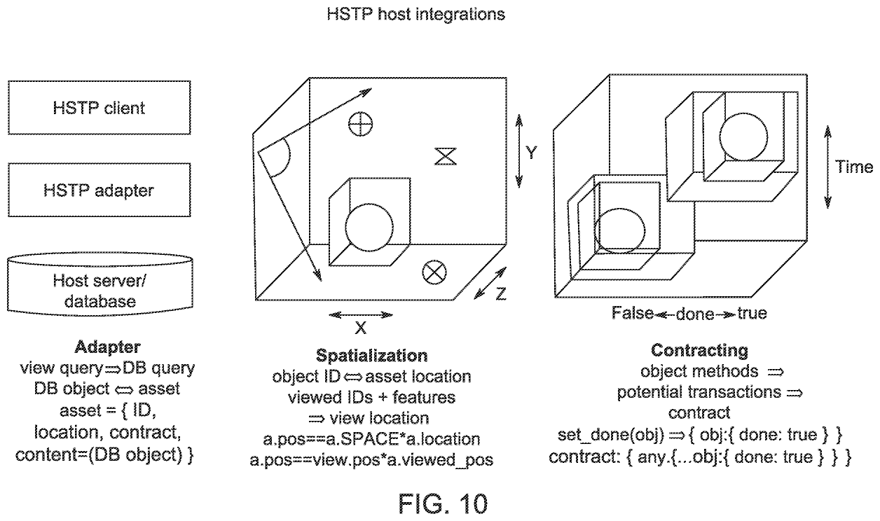

The conversion from database query to view query includes three components: Adapter, Spatialization, Contracting, as depicted in FIG. 10.

In the Adapter component, the HSTP Adapter interacts with the HSTP Client and the Host Server/Database to take Spatial View Queries and convert them into Database Queries and converts the resulting DB Objects into Spatial Assets.

During Spatialization, the Asset Location is queried based on the asset ID. Other View IDs and features can also be used to provide for view location triangulation, discussed above (also referred to here as VIEW LOCATION).

Finally, during Contracting, Object Methods are translated into permissible transactions that will make up a Contract.

Queried assets are then stored into the asset cache.

Since the asset, which may include an item, an owner, or a space, may all include certain constraints or permissions, each may be defined as a separate contract supported by a separate ledger. For instance, moving an object between spaces (changing the “SPACE” property) requires the old space, new space, owner, and asset to all be validated contractually. Thus, there are typically between 3 and 5 contracts evaluated per asset change (the asset itself, old space, old owner, new space, new owner). If the owner/space exists on a separate ledger, a full implementation must request the asset's current state (excluding content, but including location) to define a spatial domain, which is sufficient to ensure that the contract is validated.

By having a separate owner contract with permissions associated with the owner, the present implementation allows for remote approval. For example, sales regulations in a particular State may define permissible transactions for specific retail operations in that State. Specifically, they may restrict who can buy alcohol. Even though the identity of the owner and range parameters (e.g., age) are not made available, they are inherent in the permissions, thereby supporting privacy models such as GDPR. This also allows more efficient validated trading without having to get written approval, yet still be bounded by official regulations; the approval being expressed as a valid range of transactions.

Thus, every ID is not only a string but a series of authority endpoints

It will be appreciated that by providing for visual contract validation, primarily through geometric intersections that allows multidimensional ranges to be defined, the HSTP implementation allows a user to visually see the contract terms and ensure compliance in space-time.

In one embodiment, visualization can also serve as an input method to define the tasks to be performed in a contract. For example, a manager can be presented with a visual depiction of a warehouse on a touch-sensitive screen, which then allows the manager to point and say “move that” (geometry bounded reference) “to there” (geometric bounds). This could generate the contract, which completes when that item is moved to the correct location.

The contracts in the HSTP context define the expressions that govern the validity of any transaction within their scope, both spatially and with respect to ownership, by associating the contract terms with the various assets.

As indicated above, an asset may comprise:
an ID,
an OWNER (which defines who owns it),
a SPACE with an ID and Ledger String, and
a LOCATION (which defines where it exists in space)—which supports any coordinate system, and also supports a point (value) and a range (min and max), and resolution for the SPACE.

As discussed above, by defining both the space and the owner as part of the HSTP, it allows them to exist on separate ledgers (separate from the asset itself). Thus, the SPACE can, for instance, be on a blockchain and verified by the blockchain, while the OWNER can be verified by biometric validation, and the asset respects both instances but exists on a separate platform e.g. cloud-based for real-time interaction.

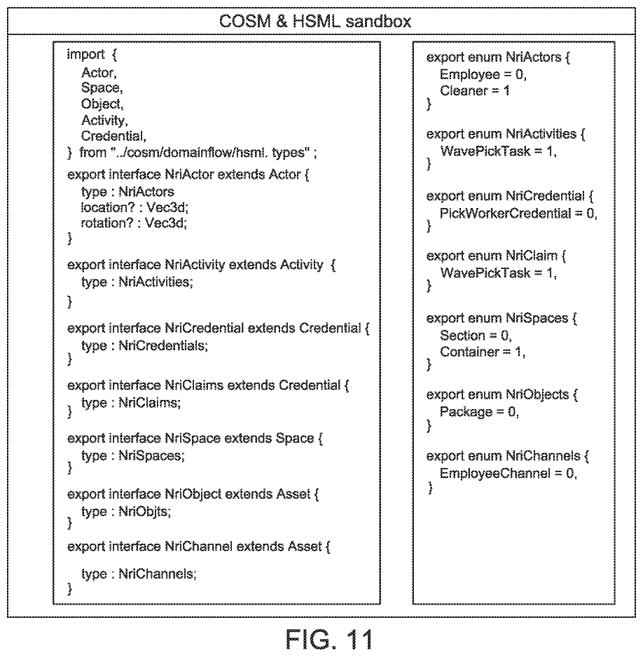

For purposes of implementation of the system, one embodiment makes use of COSM (which does the fundamental credentialing and contract term verification) by importing the basic types that COSM knows to work with, similar to the way one would use a Java Script package. Some of the basic types associated with COSM include: Actor, Authority, Domain, Right, Activity, Object, Space, Reality, Time, Credential, Claim, Channel, and which can be extended as shown in the example of FIG. 11.

In a warehouse implementation the types could correspond to the various assets as follows: an employee (Actor/User) by virtue of employment at a warehouse (Authority) and within the relevant (Domain) has the right (Right) to perform a wavepick (Activity) on an ecommerce item (Object) at a given container bin (Space) in the physical world (Reality) during work hours (Time), given a pick worker credential (Credential) presented in the form of claim (Claim) through the Warehouse picker channel (Channel)

The basic connections with the underlying graph database can be inherently achieved using a type script language which places constraints on the values the particular variables can take. The effect is that if you attempt to interact with your graph database with an object that doesn't meet the HSML schema it will tell you even before you run the program.

In one implementation Apache Spark (a data analytics solution) is hooked up with Gremlin, which provides an interface to different graph database languages such as Neo4j, GraphDB, ArangoDB) and which also makes it easier to use a programming language rather than a database language with Kafka, (which allows multiple data stream modalities to be serialized). The data streams from Kafka are analyzed in Spark and once verified in the digital twin, are fed back to update the digital twin in the graph database. (ArangoDB in this case).

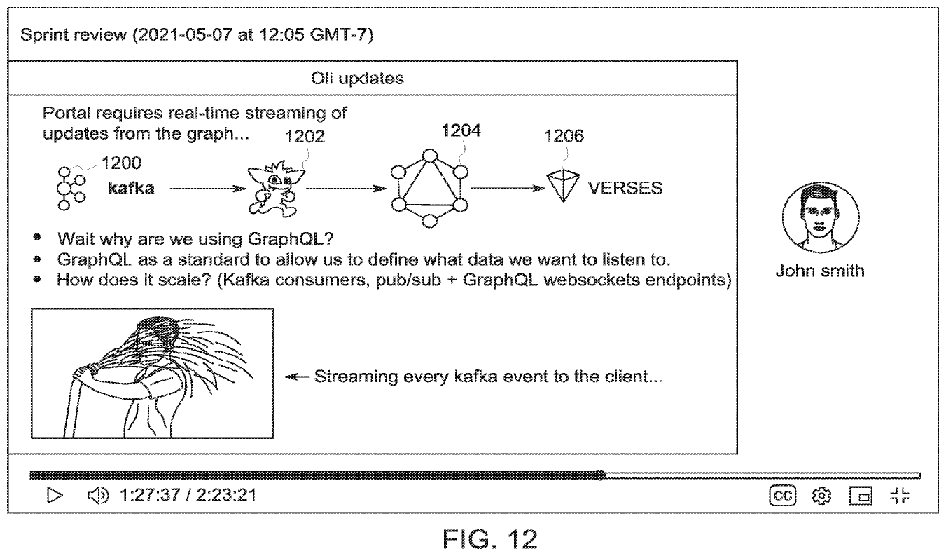

Instead of streaming Kafka events directly to the client (ie to the portal), GraphQL was interspersed to enable data queries to the graph database. The data flow is illustrated in FIG. 12, where the serialized data streams from Kafka 1200 are fed into Gremlin 1202 to provide an agnostic graph database interface. Arrango QL 1204 is provided in this data flow to provide an open-source data query and manipulation language for APIs, and a runtime for fulfilling queries to the COSM instance 1206 (depicted here by the parent name Verses).

While the present invention was described with respect to specific embodiments, it will be appreciated that it can be implemented in different ways without departing from the scope of the invention.

1. A system for locating an item in a warehouse comprising, a user or cart tracking device;
location markers or visually identifiable features associated with one or more of a user, a cart, and sections or items in the warehouse, wherein the user tracking device includes:
a processor with control memory configured with machine readable code defining an algorithm,
at least one location information capture device connected to the processor for capturing information from the location markers or visually identifiable features, and
a user screen for displaying a 2-dimensional or 3-dimensional virtual representation of the warehouse, wherein the algorithm is configured to use the information captured by the location information capture device to spatially locate the user or cart in the warehouse, and display the location of the user or cart on the virtual representation, and wherein the algorithm is configured to display the location of the item on the virtual representation of the warehouse.

2. A system of claim 1, wherein the algorithm includes logic for defining the optimum route from the location of the user or cart to the location of the item.

3. A system of claim 2, wherein the location markers include one or more of beacons, floor markers, and barcodes located on one or more of warehouse floor, warehouse racks, shelves on racks, containers on the shelves, users, and carts or other conveyances in the warehouse.

4. A system of claim 2, wherein the algorithm includes logic for generating an augmented reality (AR) image as an overlay to a view of the warehouse to guide the user to a defined location in the warehouse.

5. A system of claim 3, wherein the location information capture device includes one or more of: a beacon signal receiver, a video camera, and a barcode reader.

6. A system of claim 5, wherein the at least one location information capture device includes at least one video camera mounted to capture location markers on the floor of the warehouse, and a barcode reader for providing more detailed location information of the tracking device or for validating an item to be located.

7. A system of claim 5, wherein the algorithm includes one or more of: logic for interpreting barcode information captured by the cameras, and logic for generating bounding boxes.

8. A system of claim 7, wherein the at least one video camera includes two or more stationary cameras mounted to view different areas of a warehouse, and wherein the algorithm is configured to define a user's location by one or more of: capturing barcode information mounted on the user or cart used by the user, and interpreting changes in the size of a bounding box generated around the user or cart used by the user.

9. A system of claim 3, further comprising a memory configured with item-identifying data that includes location data for each respective item or for each respective container containing an item or family of items.

10. A system of claim 9, wherein the screen further displays a virtual representation of the shelf where the item of interest is located, with a visual identifier for the location as defined by the location data of the item of interest.

11. A system of claim 10, further including a hand-operated barcode scanner for scanning barcodes on shelves in order to validate the shelf of the item of interest, the algorithm generating a visual or audible confirmation that the correct shelf has been scanned or issues an alert that the wrong shelf has been scanned.

12. A system of claim 10, wherein the tracking device is mounted on a cart used by a user to pick items from shelves or place items on shelves.

13. A system of claim 12, wherein the user screen includes a virtual representation of the cart, and compartments for receiving items, in the case of a multiple-compartment cart, with visual depiction of what compartment to place the item in or extract the item from.

14. A system of claim 13, further comprising a microphone to audibly guide the user.

15. A system of claim 14, wherein the audible guidance includes vocalized instructions guiding the user to the item location and identifying what compartment to place the item in during a placing task, or what compartment to extract the item from during a picking task.

16. A system of claim 12, further comprising a mobile printer connected to the processor for printing shipping labels for items to be shipped.

17. (canceled)

18. (canceled)

19. (canceled)

20. A method of improving warehouse efficiency, comprising providing a virtual twin of the warehouse and visually depicting the items in the warehouse on the virtual twin,
classifying items in the warehouse in order of priority based on frequency of picking,
defining one or more primary regions in the warehouse that are optimally located for shipping items, and
visually depicting on the virtual twin, the optimum distribution of each item relative to the one or more primary regions in accordance with each item's priority level.

21. A method of claim 20, further comprising taking into account location on a rack as a factor in optimizing distribution.

22. A method of claim 20, further comprising tracking activities performed on items by depicting said activities on the virtual twin.

23. A method of claim 20, further comprising depicting current locations of items on the virtual twin, as well as their optimum distribution.

24. A method of claim 20, wherein the virtual twin is displayed on a screen, the method further comprising displaying on the screen, activities performed on an item and the time taken and path traveled in performing the activity.

25. A method of claim 20, further comprising providing a real-time depiction of users in the warehouse on a digital twin of the warehouse.

26. A method of claim 20, further comprising providing a dashboard to provide access to all assignments per user.

27. A method of claim 20, wherein the assignments include one or more of: current, historical, and future assignments.

28. A method of claim 26, wherein the dashboard includes the option to display different pick types allocated to each user for the day, including wave, discrete and fast picks.

29. A method of claim 26, wherein the dashboard displays task assigned, by brand and by user.

30. A method of claim 26, wherein the dashboard includes viewing one or more of: total picks per hour (TPH), total time taken by each user per task, total time taken by each user per day, total time for all users per day, and number of assignments completed that day.

31. A method of claim 20, further comprising optimizing the number of pickers that are required, based on a known number of assignments to be performed in a given time-frame.

32. A method of claim 20, further comprising optimizing distances between items and fulfillment zones (also referred to as shipping or packing locations) based on frequency of picks of said items and distance or time to a fulfilment zone.

33. A method of claim 20, further comprising optimizing the route taken by a user based on the need for the user to pick or place multiple items at different locations.

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. A method of claim 47, wherein a copy of the spatial index is maintained in a block chain.

52. A system of claim 2, wherein the optimum route includes the shortest distance or shortest time path, and the optimum route is displayed on a user screen to visually guide the user to the at least one item or the user is guided along the optimum route to the at least one item by means of auditory instructions.

53. A system of claim 52, wherein if multiple items need to be picked or placed at different locations, the algorithm in configured to determine the optimum order in which to pick the items.
